(19) United States
(12) Patent Application Publication
(10) Pub. No.: US 2008/0013718 A1
(43) Pub. Date: Jan. 17, 2008

(54) Image processing apparatus, image processing method and image processing program

(75) Inventor: Tomoyuki Okamoto, Suita-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Tokyo (JP)

(21) Appl. No.: 11/783,497

(22) Filed: Apr. 10, 2007

(30) Foreign Application Priority Data
Apr. 24, 2006 (JP) 2006-119120

(51) Int. Cl. H04K 1/00

(52) U.S. Cl. 380/30

(57) ABSTRACT

The scanner apparatus incorporating a scanner section, a printer section, an operator panel section, a storage section, a network communication section and a processing section is connected to various terminal units, such as a client terminal, via a network. This scanner apparatus is operable, when data is stored in a box, to generate a common key on a data-by-data basis so as to encrypt the entire data using the common key, and then encrypt only the common key using a public key assigned to each box. The present invention can provide means for use in a network system where an image processing apparatus and others are connected to each other via a network, to allow digital data, such as document data or image data, to be encrypted/decrypted without deterioration in processing speed and processing efficiency.

### RELATED APPLICATION

This application is based on Japanese Patent Application No. 2006-119120, the contents of which are incorporated herein by reference.

### BACKGROUND OF THE INVENTION

The present invention relates to an image processing apparatus connectable to a network, an image processing method for use in the image processing apparatus, and an image processing program for allowing a computer to execute the image processing.

Generally, digital data, such as document data or image data, to be exchanged or saved in a network system where a computer, a printer, a scanner apparatus, a complex machine and others are connected to each other via a network, is exposed to the risk of a leak of its content to a third party. As measures of this risk, there have been proposed various encryption techniques intended to allow such digital data to be exchanged or saved in an encrypted manner and then decrypted during use as disclosed in JP2003-244126A, JP2003-029955A, JP2003-242005A and JP2004-072151A.

Specifically, JP2003-244126A discloses a network system designed to such that, when received data is stored in a folder specified by a destination of the data, the data is encrypted using a public key associated with the folder so as to ensure the security of the data. JP2003-029955A discloses a printing system designed such that a print job is encrypted using a public key and decrypted using a private key while associating voice information with the key pair, so as to reduce the risk of data leak during printing. JP2003-242005A 3 discloses a document management system designed such that, when a user intends to encrypt a specific file in a folder, a public key of the user is acquired from a network server to encrypt the file, and the encrypted file is distinctively displayed with an icon. JP2004-072151A discloses a network system designed to maintain the security for files through file encryption while allowing a part of the encrypted files to be shared between terminals.

In the conventional encryption techniques used in this type of network system, when a processing based on a symmetric-key encryption scheme is performed in a device, such as a scanner apparatus, an information processing load is extremely increased to cause a problem, such as deterioration in processing speed and processing efficiency.

### SUMMARY OF THE INVENTION

In view of the above conventional problem, it is an object of or a problem to be solved by the present invention to provide means for use in a network system where an image processing apparatus and other apparatus are connected to each other via a network, to allow digital data, such as document data or image data, to be encrypted/decrypted without deterioration in processing speed and processing efficiency.

In order to achieve the above object, the present invention provides an image processing apparatus which comprises a storage section, a common-key generation section, an encrypted-image-data generation section and an encrypted-common-key information generation section. The storage section has a plurality of individual storage areas (boxes) each adapted to be associated with a public key. The common-key generation section for generating a common key corresponding to image data. The encrypted-image-data generation section is operable to encrypt the image data using the common key to generate encrypted image data. The encrypted-common-key information generation section is operable encrypt the common key using the public key to generate encrypted-common-key information. The image processing apparatus is designed to store the encrypted-common-key information in one of the individual storage areas which is associated with the public key used in generating the encrypted-common-key information.

The present invention also provides an image processing method which comprises the steps of associating a public key with a specific one of a plurality of individual storage areas formed in a storage section of an image processing apparatus, generating a common key corresponding to image data, encrypting the image data using the common key to generate encrypted image data, encrypting the common key using the public key to generate encrypted-common-key information, and storing the encrypted-common-key information in the specific individual storage area associated with the public key used in generating the encrypted-common-key information.

Further, the present invention provides an image processing program for allowing a computer to execute a procedure which comprises the steps of associating a public key with a specific one of a plurality of individual storage areas formed in a storage section of an image processing apparatus, generating a common key corresponding to image data, encrypting the image data using the common key to generate encrypted image data, encrypting the common key using the public key to generate encrypted-common-key information, and storing the encrypted-common-key information in the specific individual storage area associated with the public key used in generating the encrypted-common-key information.

### BRIEF DESCRIPTION OF THE DRAWINGS

Various characteristics and advantages of the present invention will become clear from the following description taken in conjunction with the preferred embodiments with reference to the accompanying drawings throughout which like parts are designated by like reference numerals, in which:

FIG. 1 is a schematic block diagram showing the configuration of a scanner apparatus according one embodiment of the present invention;

FIG. 2 is a schematic diagram showing information of a box included in the scanner apparatus illustrated in FIG. 1;

FIG. 3 is a schematic diagram showing a data encryption scheme for use in a scanner apparatus according to one embodiment of the present invention;

FIG. 4 is a flowchart showing a procedure for encrypting data scanned by the scanner apparatus illustrated in FIG. 1;

FIG. 5 is a schematic diagram showing a data arrangement during a process of keeping encrypted data in a scanner apparatus according to one embodiment of the present invention;

FIG. 6 is a schematic diagram showing a data arrangement during a process of disclosing encrypted data to another box in a scanner apparatus according to one embodiment of the present invention;

FIG. 7 is a schematic diagram showing a data arrangement during a process of printing out encrypted data in a scanner apparatus according to one embodiment of the present invention;

FIG. 8 is a schematic diagram showing a data arrangement during a process of storing a transfer record using an electronic signature scheme in a scanner apparatus according to one embodiment of the present invention;

FIG. 9 is a schematic diagram showing a data arrangement in a case where a plurality of scanner apparatuses according to one embodiment of the present invention are connected to a network in a linked manner;

FIG. 10 is a schematic diagram showing a data arrangement in a case where a scanner apparatus according to one embodiment of the present invention has its own symmetric keys to achieve enhanced processing efficiency; and

FIG. 11 is a schematic diagram showing a data arrangement in a case where a scanner apparatus according to one embodiment of the present invention is designed to generate temporary symmetric keys.

### DETAILED DESCRIPTION OF THE PREFERRED EMBODIMENTS

With reference to the accompanying drawings, the best mode (embodiment) for implementing the present invention will now be specifically described. While this embodiment will be described in connection with a scanner apparatus as a typical image processing apparatus, an image processing apparatus as a subject matter of the present invention is not limited to such a scanner apparatus, but it is understood that the present invention may also be applied to various other image processing apparatuses, such as a printer and a complex machine. Further, an image processing method or procedure in the following description may be implemented using a program of the present invention.

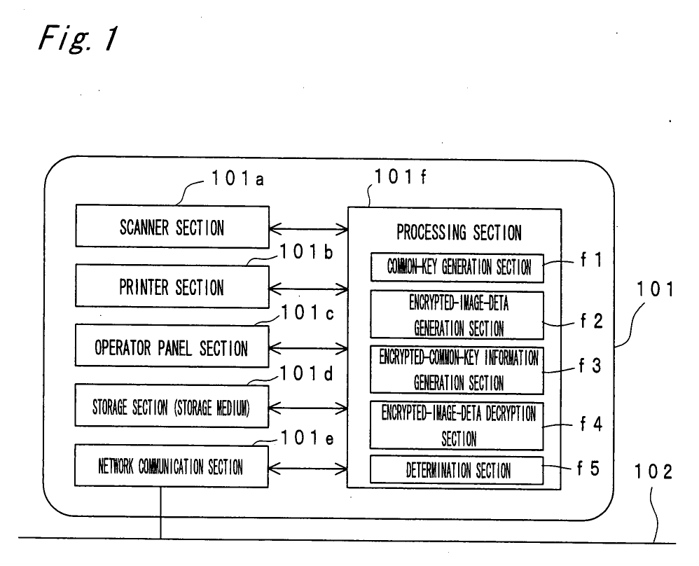

FIG. 1 is a schematic diagram showing the configuration of a scanner apparatus according to one embodiment of the present invention. As shown in FIG. 1, the scanner apparatus 101 (network scanner apparatus) is connected to a network 102 in such a manner as to data to be exchanged with or transmitted/received to/from other terminal unit (e.g. a personal computer, a printer, a complex machine, etc.) connected to the network 102. In this embodiment, the network 102 is a local area network (LAN) established, for example, in a company, and can be achieved using an interface, such as 10/100 Base-T or 1000 Base-T.

The scanner apparatus 101 incorporates a scanner section 101a, a printer section 101b, an operator panel section 101c, a storage section (storage medium) 101d, a network communication section 101e and a processing section 101f. Although not illustrated in detail, the scanner section 101a comprises a light source, a prism and a CCD, and has a function of scanning a text document or an image document at a given resolution and converting the scanned document data to electronic data through a given image processing. Although not illustrated in detail, the printer section 101b comprises, for example, an electrophotographic mechanism, and an ink jet mechanism or a thermal transfer mechanism, and has a function of outputting electronic data, such as a print job, onto a surface of a sheet in the form of an image.

For example, the operator panel section 101c is a touch panel type. The operator panel section 101c comprises a mechanism for allowing an operator or user to enter various instructions therethrough, and a device for displaying a message to the user. Although not illustrated in detail, the storage section 101d comprises a hard disk drive (HDD) and a nonvolatile memory, and stores various data and software for the scanner apparatus 101. The network communication section 101e is connected to the network 102 to serve as a means to communicate with other apparatus connected to the network 102, and may be achieved using a network interface card (NIC). Although not illustrated in detail, the processing section 101f may be achieved using a combination of a microprocessor (CPU) and a random access memory (RAM), to perform various controls/processings for the entire scanner apparatus 101.

The processing section 101f is operable to perform various processings as well as controls for respective sections of the scanner apparatus 101. The processing section 101f comprises a common-key generation section f1, an encrypted-image-data generation section f2, an encrypted-common-key information generation section f3, an encrypted-image-data decryption section f4, and a determination section f5. The common-key generation section f1 is operable to generate a common key K corresponding to image data. The encrypted-image-data generation section f2 is operable to encrypt the image data using the common key K to generate encrypted image data.

The encrypted-common-key information generation section f3 is operable to encrypt the common key K using a public key A to generate encrypted-common-key information. The encrypted-image-data decryption section f4 is operable to decrypt the encrypted image data using the common key K to obtain decrypted image data. The determination section f5 is operable to determine whether a specific one of a plurality of individual storage areas (boxes) of the storage section 101d which is targeted for storing the image data generated by the scanner section 101a is associated with a public key A.

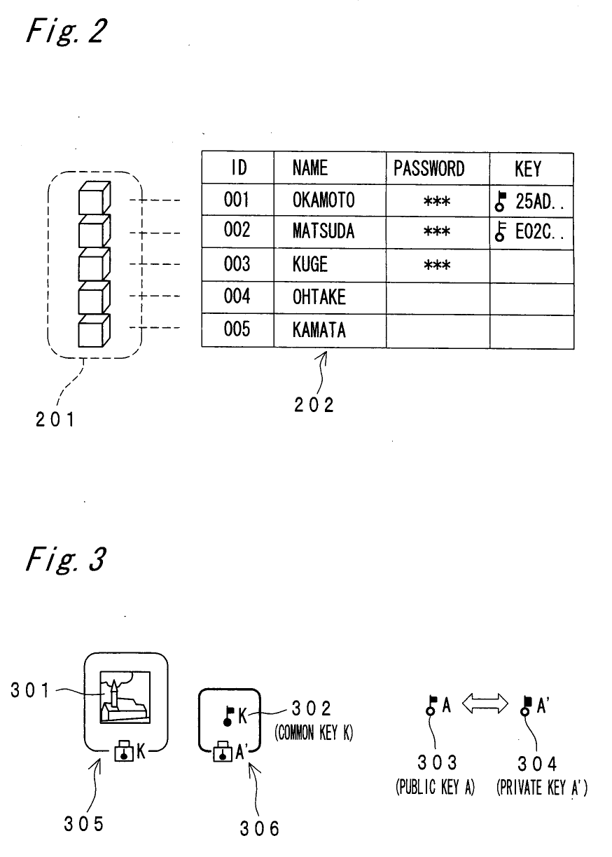

FIG. 2 is a schematic diagram showing information which is held in the storage section 101d of the scanner apparatus 101 illustrated in FIG. 1 to manage a plurality of user's boxes (user-specific storage areas). As shown in FIG. 2, there is a virtual box group 210 in the storage section 101d, and the virtual box group 210 includes a plurality (five in the example illustrated in FIG. 2) arranged in one line and assigned, respectively, to a plurality of users. The respective boxes in the virtual box group 210 are managed by a box management table 202.

In the box management table 202, the item “ID” indicates a serial number of each of the boxes, and this serial number uniquely represents an actual physical position of the box. The item “Name” is a sequence of alphabets (letters) representing the name of a user associated with each of the boxes, i.e. an alphabet sequence associated with a specific user to have a user authenticating function. The item “Password” represents a password associated with each of the boxes, and a password associated with a specific user to have a user authenticating function. The item “Key” represents a public key associated with each of the boxes. The public key is binary data of about 512 to 1024 bites, which holds data, the so-called “electronic certificate”. For example, the box having the “ID”: 001, and the item “Name”: Okamoto, has a password “***” and a public key consisting of a character sequence which starts from “25AD - - - ”.

FIG. 3 is a schematic diagram showing an encryption scheme for use in a scanner apparatus 101 according to one embodiment of the present invention, and represents encryption and decryption modes of image data 301. This image data 301 is electronic data converted from an image obtained by scanning. A common key 302 is a temporary key generated for the purpose of encrypting the image data 301, and used in a common-key encryption algorithm, such as 3DES or ASE. This common key 302 (K) is a common key to be generated with respect to each scanning, i.e. a common key to be differently varied every scanning. A public key 303 (A) is used together with a private or private key 304 (A′) in a paired manner, and used in a symmetric-key encryption algorithm, such as RSA or DSA. Data encrypted by the public key 303 can be decrypted only by the private key 304, and data encrypted by the private key 304 can be decrypted only by the public key 303. In view of this feature of these keys 303, 303, the former encryption is utilized to keep the confidentiality of data, and the latter encryption is utilized for user authentication based on electronic signature to the data. In this embodiment, the common key is generated in such a manner as to be differently varied every scanning, as described above. Alternatively, the common key may be generated randomly every scanning. Further, the common key may be generated in such as manner as to be differently varied or generated randomly, on a user-by-user basis or every a given number of times of scanning.

A common-key encryption algorithm is used in the encryption scheme for encrypting the image data 301 using the common key 302 to obtain encrypted data 305 (encrypted image data). This makes it possible to achieve enhanced processing efficiency in encryption of the image data 301. Further, a symmetric-key encryption algorithm is used in the encryption scheme for encrypting the common key 302 using the common key 302 to obtain encrypted data 306 (encrypted common key data). Thus, the encrypted data 306 of the common key 302 can be decrypted only by the private key 304. Therefore, the encrypted data 305 and the encrypted data 306 can be kept in a paired state so as to provide a high-security environment such that the image data 301 cannot be accessed without using the private key 304.

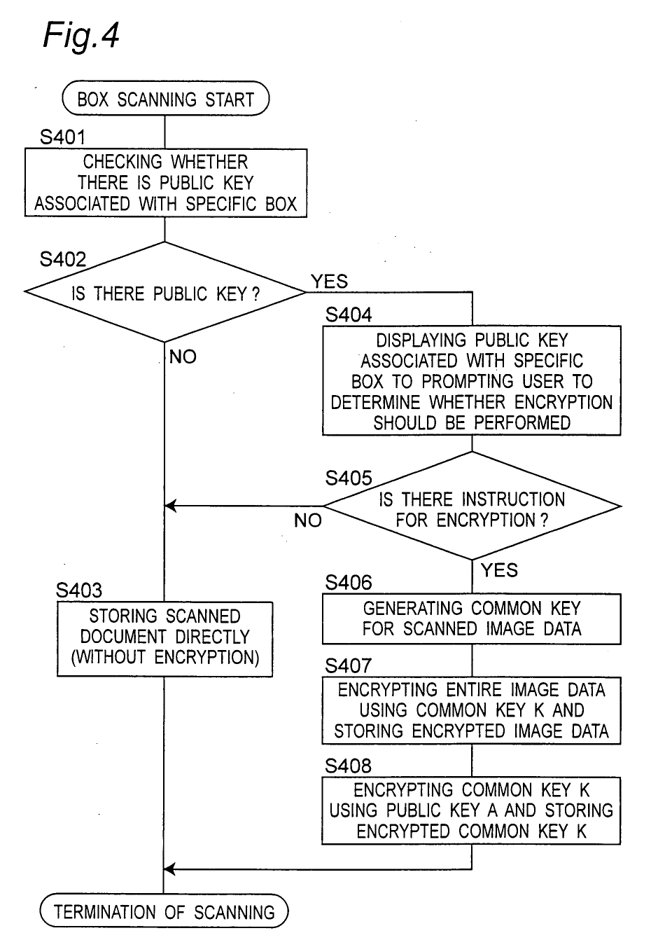

FIG. 4 is a flowchart showing a procedure or process for encrypting image data scanned by the scanner apparatus 101 illustrated in FIG. 1. Based on the flowchart illustrated in FIG. 4, the procedure of the above encryption processing will be specifically described below. In this encryption processing, a user firstly operates the operator panel section 101c of the scanner apparatus 101 to issue an instruction for scanning a text or image document (hereinafter referred to collectively as “document”) and storing (saving) image data to be obtained by scanning, into a specific one of the boxes (Box Scanning Start). In response to this instruction, the scanner apparatus 101 checks whether there is a public key 303 associated with the specific box (Step S401), to determine whether there is the public key 303 (Step S402).

If the determination in Step S402 is “NO” or it is determined that there is no public key 303 associated with the specific box, image data of the scanned document will be stored in the specific box directly without encryption thereof (Step S403), and this scanning operation will be terminated. When the determination in Step S402 is “YES” or it is determined that there is the public key 303 associated with the specific box, the public key 303 associated with the specific box is displayed on the operator panel section 101c to prompt the user to determine whether the image data should be encrypted (Step S404). Then, user's instruction about encryption of the image data is checked (Step S405). If the user has issued no instruction about encryption of the image data (NO in Step S405), the data of the scanned document will be stored in the specific box directly without encryption thereof (Step S403), and this scanning operation will be terminated.

When the user has issued the instruction about encryption of the image data (YES in Step S405), a common key 302 for the image data 301 obtained by scanning the document is generated by use, for example, of random number generation means (Step S405). Then, the entire image data 301 is encrypted using the generated common key 302 (K), and the encrypted image data 301 is stored (Step S407). Further, the common key 302 is encrypted using the public key 303 (A), and the encrypted common key 302 is stored (Step S408). Then, this scanning operation is terminated.

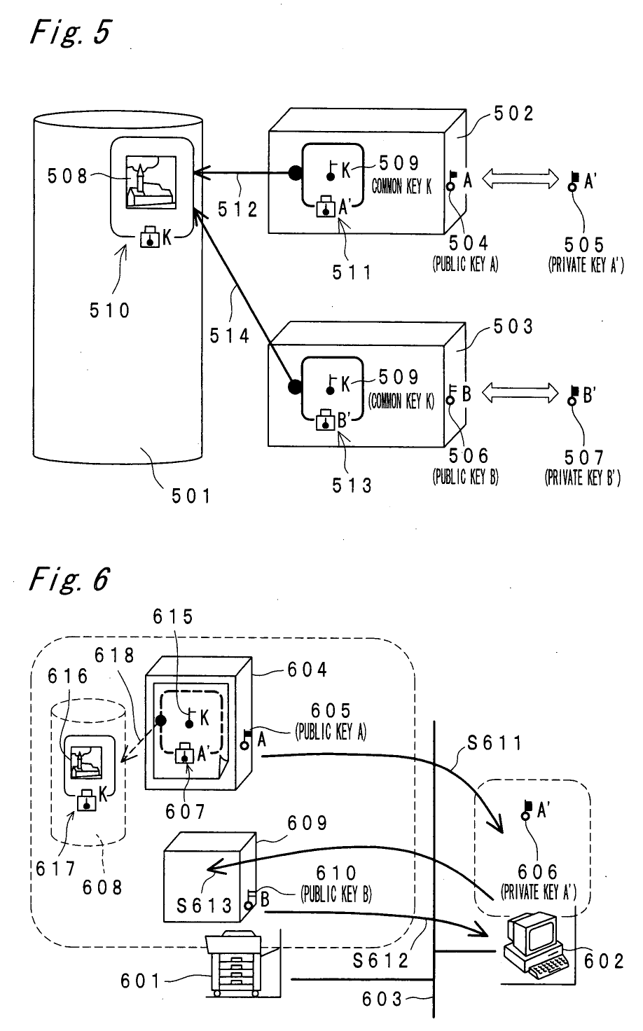

With reference to FIGS. 5 to 11, some examples of encryption processing in a scanning apparatus according to one embodiment of the present invention will be specifically described below.

FIG. 5 is a schematic diagram showing a data arrangement during a process of efficiently arranging data resulting from encrypting image data scanned by a scanner apparatus according to one embodiment of the present invention, or showing a virtual data arrangement in a storage section 101d. In FIG. 5, an image storage (image storage area) 501 is a storage area for storing image data 508 or encrypted data 510 obtained by encrypting the image data 508 using a common key 509 (K). Each of two boxes 502, 503 is a storage area provided in the scanner apparatus to keeping box information. The box 502 and the box 503 are associated, respectively, with a public key 504 (A) and a public key 506 (B).

A private key 505 (A′) and a private key 507 (B′) are paired, respectively, with the public key 504 (A) and the public key 506 (B). These private keys 505, 507 are used in a symmetric-key encryption algorithm. The image data is electronic data of image obtained by scanning a document. This image data 508 is encrypted using the common key 509 produced every scanning or during scanning, and resulting encrypted data 510 is stored (save) in the image storage 501. In this embodiment, the common key 509 to be generated every scanning means a common key to be generated every job. Alternatively, the common key may be generated in such a manner as to be differently varied on a page-by-page basis even within a single job.

The common key 509 is encrypted using the public key 504 so as to store resulting encrypted data 511 in the box 502, and encrypted using the public key 506 so as to store resulting encrypted data 513 in the box 503. Further, the box 502 and the box 503 store, respectively, link information 512 and link information 514 each linking to the encrypted data 510 stored in the image storage 501. This is substantially equal to a state in which the encrypted data 510 resulting from encrypting the image data 508 is stored in each of the box 502 and the box 503. This data arrangement allows each of the box 502 and the box 503 to be provided with image data which can be decrypted (decoded) only by the private key 505 and the private key 507. In addition, this advantage can be obtained by storing only one encrypted data 510 obtained by the image data 508, in the image storage 501. This makes it possible to achieve efficient data arrangement. Further, in addition to the link information 512 and the link information 514, document information, such as document title, creation date and document preparer (when the (image) document is a scanned document, a person who has performed the scanning operation) may be stored in the box 502 in association with the encrypted data 511. This makes it possible to eliminate the need for vexatiously decrypting the encrypted data 510 when a user intends to display a list of documents in the box 502, and display the list based on the stored document information.

FIG. 6 is a schematic diagram showing a procedure for disclosing (moving/copying) an encrypted electronic document disclosed based on the encryption scheme of the present invention, in a network scanner apparatus according to one embodiment of the present invention. As shown in FIG. 6, the scanner apparatus 601 according to this embodiment is connected to a client terminal 602 via a network 603. For example, this scanner apparatus 601 is equipped with a HTTP server function. A user can access the scanner apparatus 601 through a Web browser operating on the client terminal 602, to use various functions of the scanner apparatus 601.

In the scanner apparatus 601, an image storage 608 stores image data 616 or encrypted data 617 resulting from encrypting the image data 616 using a common key 615 (K). The scanner apparatus 601 discloses a box 604 associated with a public key 605 (A), and a box 609 associated with a public key 610 (A). The common key 615 (K) is encrypted using the public key 605, and resulting encrypted data 607 is stored in the box 604. Further, the box 604 stores link information 618 linking to the encrypted data 617 stored in the image storage 608. This is substantially equal to a state in which the encrypted data 617 resulting from encrypting the image data 616 is stored in the box 604. The client terminal 602 has a private key 606 (A′), and the encrypted data 607 encrypted by the public key 605 can be decrypted using the private key 606 to obtain the common key 615.

The encrypted data 617 resulting from encrypting the image data 616 can disclose to the box 609 according to the following procedure. The client terminal 602 acquires the encrypted data 607 resulting from encrypting the common key 615, and then decrypts the encrypted data 607 using the private key 606 to obtain the common key 615 (Step S611). Further, the client terminal 602 acquires the public key 610 via the network 603, and then encrypts the common key 615 using the public key 610 (Step S612). Then, this encrypted common key 615 is transmitted (sent) to the box 609 (Step S613). Thus, in the box 609, the encrypted common key 615 can be decrypted using a private key (not shown) corresponding to the public key 610 associated with the box 609, and the encrypted data 617 can be decrypted to obtain the image data 616. The above series of steps may be automatically performed according to a script program running in the Web browser. In this manner, a document in a certain box can be disclosed (moved/copied) to another box by handling (transferring) only key data.

In an operation for browsing the image data 616 on the client terminal 602, the user accesses the box 604 from the client terminal 602, and instructs the scanner apparatus 601 to transmit image data 616 (selected based on the document information, as described above). In response to this instruction, the scanner apparatus 601 transmits the encrypted data 607 (encrypted common key 615) and the encrypted data 617 specified based on the link information 618 (encrypted image data) to the client terminal 602 which has issued the instruction. Then, in the client terminal 602, the encrypted data 607 is decrypted using the private key 606 owned by the client terminal 602, to extract the common key 615 therefrom, and the encrypted data 617 is decrypted using the extracted common key 615 so as to acquire/brows the image data 616 (document) in security.

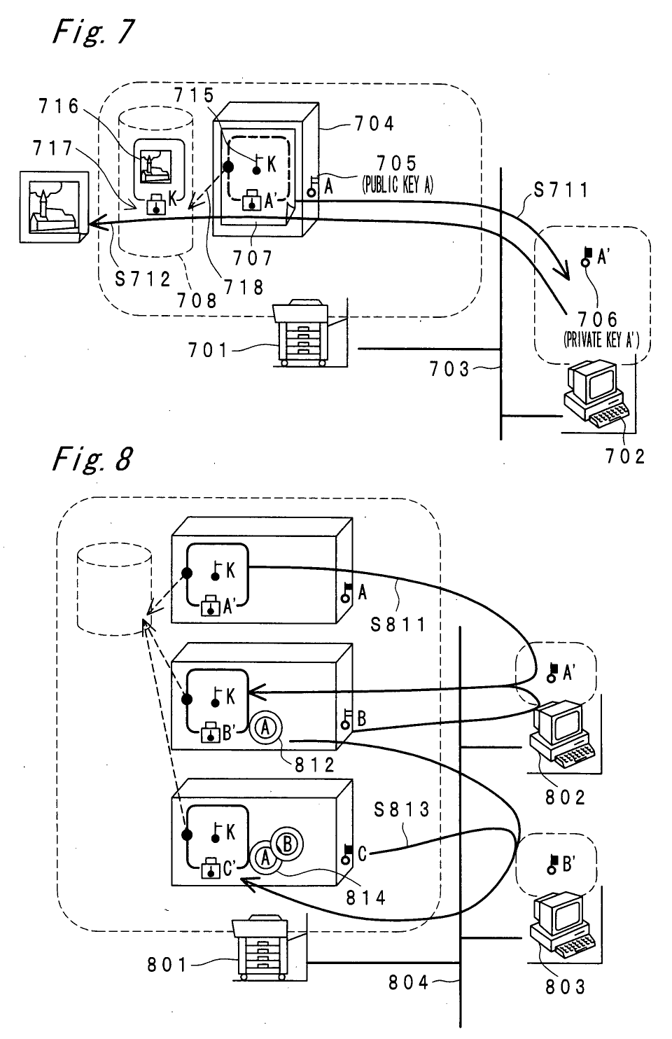

FIG. 7 is a schematic diagram showing a procedure for printing out an encrypted document disclosed based on the encryption scheme of the present invention, in a scanner apparatus according to one embodiment of the present invention. As shown in FIG. 7, a scanner apparatus 701 is connected to a client terminal 702 via a network 703, as with the embodiment illustrated in FIG. 6. In the scanner apparatus 701, an image storage 708 stores an image data 716, or encrypted data 717 resulting from encrypting the image data 716 using a common key 715 (K). The scanner apparatus 701 has a box 704 associated with a public key 705 (A). The common key 715 is encrypted using the public key 705, and resulting encrypted data 707 is stored in the box 704. Further, the box 704 stores link information 718 linking to the encrypted data 717 stored in the image storage 708. This is substantially equal to a state in which the encrypted data 717 resulting from encrypting the image data 716 is stored in the box 704. The client terminal 702 has a private key 706 (A′), and the encrypted data 707 encrypted by the public key 505 can be decrypted using the private key 706 to obtain the common key 715.

A procedure for printing out the image data 716 (document) based on its instruction issued from the client terminal to the scanner apparatus 701 is performed as follows. The client terminal 702 firstly acquires the encrypted data 707 resulting from encrypting the common key 715, and then decrypts the encrypted data 707 using the private key 706 to obtain the common key 715 (Step S711). Further, the decrypted common key 715 is transmitted to the box 704. Then, the scanner apparatus 701 decrypts the encrypted data 717 using the received common key 715, and the printer section 101b outputs the decrypted image data 716 onto a surface of a sheet (Step S712). In this manner, the image data 716 (electronic document) can be printed out by exchanging only the common key 715 or the encrypted data 707 thereof via the network 703. This makes it possible to protect the image data 716 and increase the processing speed.

FIG. 8 is a schematic diagram showing a procedure in a case where a function of recording (tracing) the history of a person who has disclosed a document is added to the procedure illustrated in FIG. 6. In the procedure illustrated in FIG. 8, an electronic signature are added to encrypted key information when the encrypted document is disclosed to another box in the procedure illustrated in FIG. 6, so as to allow a person who has disclosed a document to be recorded (traced).

As shown in FIG. 8, the scanner apparatus 801 is connected to a client terminal 802 and a client terminal 803, via a network 804, as with the embodiment illustrated in FIG. 6. The scanner apparatus 801 provides individual boxes to the client terminals 802, 803, respectively. A procedure for disclosing an encrypted document of a certain box to another box is performed as follows.

When an encrypted document in the box A is disclosed from the client terminal 802 to the box B (Step S811) in the same manner as the corresponding step of the procedure illustrated in FIG. 6, an electronic signature 812 is added to data about the disclosure, using a private key A1. In the same way, when an encrypted document in the box B is disclosed from the client terminal 803 to the box C (Step S813) in the same manner as the corresponding step of the procedure illustrated in FIG. 6, an electronic signature 814 is added in such a manner as to be superimposed on the above electronic signature 812.

When a plurality of transfers are repeatedly performed, electronic signatures may be added in a nesting manner to ensure the transfer history based on the electronic signatures.

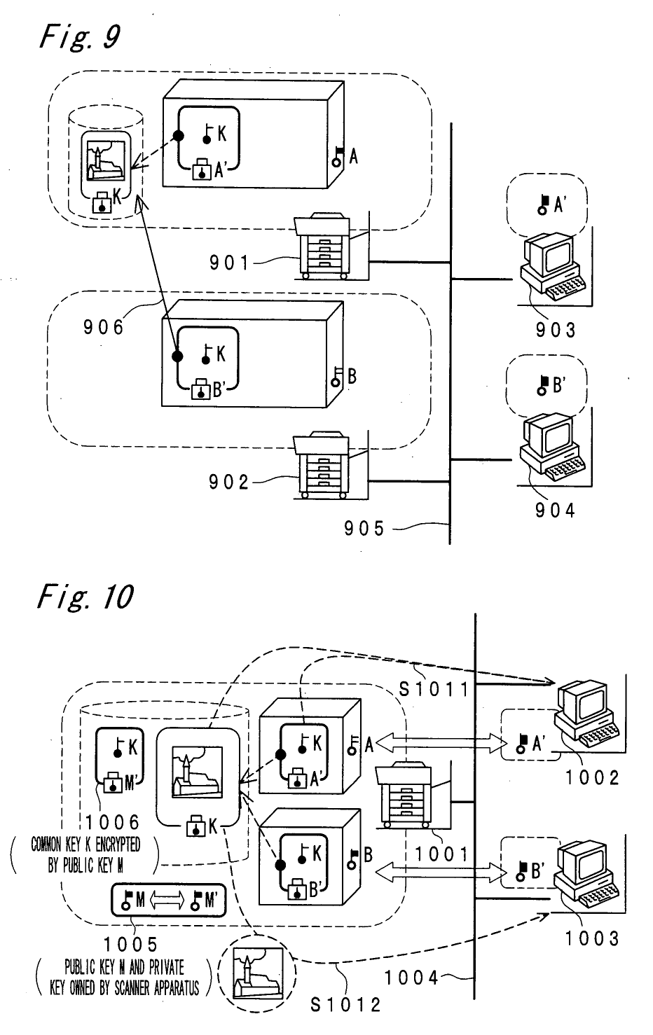

FIG. 9 is a schematic diagram showing an encryption procedure in a case where two of the scanner apparatuses are used in a linked manner across a network. As shown in FIG. 9, a scanner apparatus 901 and a scanner apparatus 902 are connected to a client terminal 903 and a client terminal 904, via a network 905, as with the embodiment illustrated in FIG. 6. Each of the scanner apparatus 901 and a scanner apparatus 902 provides corresponding individual boxes to the client terminals 903, 904, respectively. When an encrypted document in the box A of the scanner apparatus 901 is disclosed from the client terminal 903 to another box as mentioned above, a user may select a box B of the other scanner apparatus 902 connected to the network 905. Thus, a common key K is stored in the box B according to the aforementioned procedure, and link information 906 linking to target image data across the network 905 is added to readily achieve desirable linkage across the network 905.

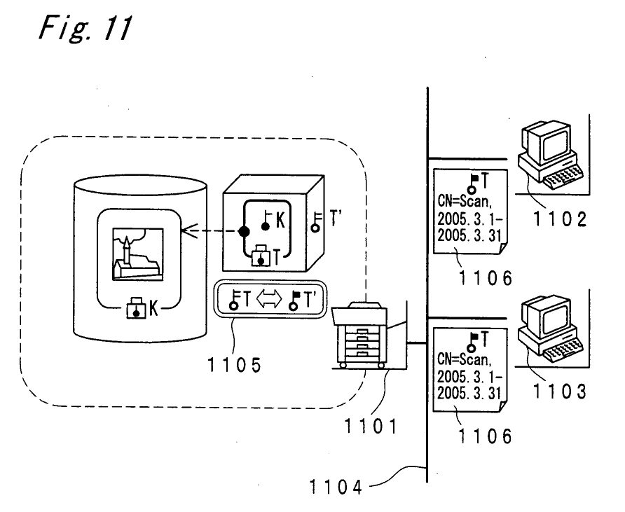

FIG. 10 is a schematic diagram showing an encryption procedure in a case where a scanner apparatus has its own symmetric keys to achieve enhanced processing efficiency. As shown in FIG. 10, a scanner apparatus 1001 is connected to a client terminal 1002 and a client terminal 1003, via a network 1004, as with the embodiment illustrated in FIG. 6. The scanner apparatus 1001 provides corresponding individual boxes to the client terminals 1002, 1003, respectively. The scanner apparatus 1001 has a symmetric key pair 10005 by itself, and keeps encrypted data 1006 resulting from encrypting a common key K using its own public key M, with respect to the entire image data.

Thus, the scanner apparatus 1001 can decrypt any encrypted image data using its own private key M′, without using private keys A′, B′ of the client terminals 1002, 1003. Therefore, the scanner apparatus 1001 allows the client terminals 1002, 1003 to download the pair of encrypted image data and encrypted common key K (Step S1011) and decrypt the data using its own private key in security. Each of the client terminals 1002, 1003 may select a process of requesting to the scanner apparatus 1001 to decrypt image data, and then downloading decrypted image data (Step S1012). Further, in response to receiving an instruction for printing from the client terminal 1002, the scanner apparatus 1001 can extract a common key K using its own private key to perform printing. This makes it possible to ensure security during printing.

FIG. 11 is a schematic diagram showing an encryption procedure in a case where a scanner apparatus is designed to generate temporary symmetric keys to provide a temporary box function. As shown in FIG. 11, a scanner apparatus 1101 is connected to a client terminal 1102 and a client terminal 1103, via a network 1104. The scanner apparatus 1101 is designed to temporarily generate a symmetric key pair in a storage section thereof, and disclose a temporary box 1105 associated with the symmetric key pair. Further, the scanner apparatus 1101 is operable to transmit (send) a temporary electronic certificate 1106 including a temporary public key, to a user who uses the temporary box 1105. A period of validity of the electronic certificate is identical to that in which the user may use the temporary box. Thus, contrary to each of the scanner apparatuses in the aforementioned embodiments, a document saved in the temporary box 1105 is allowed to be decrypted using the public key included in the temporary electronic certificate 1106. This makes it possible to provide a temporarily-secure document function capable of remove user's burden of key setting.

As mentioned in the above embodiments, the present invention can provide a secure scanner apparatus or image processing apparatus capable of allowing scanned data to be decrypted only by user's private key, based on a symmetric-key encryption scheme. The present invention can also provide a scanner apparatus or image processing apparatus capable of allowing scanned data to be decrypted using a public key included in a temporary electronic certificate, if a user desires to omit the burden of key setting.

In the image processing apparatus, the image processing method and the image processing program according to the present invention, after the entire image dada is encrypted using the common key, only the common key is encrypted using the public key. This makes it possible to drastically reduce a data processing load as compared with a case of encrypting the entire image data using the public key. In addition, the image data itself can be decrypted (decoded) only by the private key, and therefore the security of the image data can be adequately ensured. Furthermore, as compared with a case of repeatedly performing the decryption and encryption of the entire image data, the processing only for the encrypted common key can be performed with enhanced efficiency, and eventually can contribute to a high level of data encryption. Thus, the present invention allows digital data, such as document data or image data, to be encrypted/decrypted without deterioration in processing speed and processing efficiency.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An apparatus for processing an image comprising:
a storage section having a plurality of individual storage areas each adapted to be associated with a public key;
a common-key generation section for generating a common key corresponding to image data;
an encrypted-image-data generation section for encrypting said image data using said common key to generate encrypted image data; and
an encrypted-common-key information generation section for encrypting said common key using said public key to generate encrypted-common-key information;
wherein said image processing apparatus is designed to store said encrypted-common-key information in one of said individual storage areas which is associated with said public key used in generating said encrypted-common-key information.

2. The apparatus according to claim 1, wherein said storage section includes an image-data storage area for storing said encrypted image data.

3. The apparatus according to claim 2, which is designed to allow said individual storage area storing the encrypted-common-key information store to have link information for associating said stored encrypted-common-key information with said encrypted image data corresponding thereto.

4. The apparatus according to claim 1, which includes an encrypted-image-data decryption section for decrypting said encrypted image data using said common key to obtain decrypted image data.

5. The apparatus according to claim 4, which includes a printing section for printing out based on said decrypted image data.

6. The apparatus according to claim 4, wherein said encrypted-image-data decryption section is adapted to use a public key based on information about a public key to be obtained by decrypting said encrypted-common-key information using a private key.

7. The apparatus according to claim 1, wherein said individual storage areas include a first individual storage area and a second individual storage area, wherein said image processing apparatus is designed such that, when a first encrypted-common-key information stored in said first individual storage area is copied or moved into said second individual storage area, said first encrypted-common-key information is decrypted using a first private key paired with a first public key corresponding to said first individual storage area and then encrypted using a second public key corresponding to said second individual storage area so as to store resulting second encrypted-common-key information in said second individual storage area.

8. The apparatus according to claim 7, which is designed such that, when said first encrypted-common-key information stored in said first individual storage area is copied or moved into said second individual storage area, an electronic signature corresponding to said first individual storage area or an electronic signature of a user giving instruction for said copying or movement is added to said second encrypted-common-key information.

9. The apparatus according to claim 1, wherein said individual storage areas include a first individual storage area and a second individual storage area, wherein said image processing apparatus is designed such that, when said encrypted-common-key information is stored in said first individual storage area and said second individual storage area, said encrypted-common-key information is encrypted using a first public key corresponding to said first individual storage area so as to store resulting first encrypted-common-key information in said first individual storage area, and encrypted using a second public key corresponding to said second individual storage area so as to store resulting second encrypted-common-key information in said second individual storage area.

10. The apparatus according to claim 1, which has an apparatus private key and an apparatus public key, wherein said encrypted-image-data generation section is operable to encrypt said image data using said apparatus public key so as to generate apparatus encrypted image data.

11. The apparatus according to claim 10, which includes communication means operable, based on an instruction from an information processing terminal connected to said image processing apparatus, to transmit said encrypted image data and said encrypted-common-key information, to said information processing terminal, or transmit decrypted image data obtained by decrypting said apparatus encrypted image data using said apparatus private key.

12. The apparatus according to claim 1, which has a scanner section for scanning an original image to generate image data, wherein said encrypted-image-data generation section is operable to encrypt the image data generated by said scanner section, using said common key, to generate encrypted image data.

13. The apparatus according to claim 12, which includes a determination section operable to determine whether a specific one of said individual storage areas which is targeted for storing the image data generated by said scanner section is associated with a public key, and, if not, to store said image data in said specific individual storage area without encryption using said common key.

14. The apparatus according to claim 1, wherein said storage section stores at least one document information selected from the group consisting of a title, a creation date and a preparer of a document relating to said image data, in such a manner as to allow said image data-related document information to be browsed without decrypting said encrypted image data.

15. A method of processing an image comprising:
associating a public key with a specific one of a plurality of individual storage areas formed in a storage section of an image processing apparatus;
generating a common key corresponding to image data;
encrypting the image data using said common key to generate encrypted image data;
encrypting said common key using said public key to generate encrypted-common-key information; and
storing said encrypted-common-key information in said specific individual storage area associated with said public key used in generating said encrypted-common-key information.

16. A program, embedded in a computer readable medium for allowing a computer to execute a procedure for processing an image, said procedure comprising:
associating a public key with a specific one of a plurality of individual storage areas formed in a storage section of an image processing apparatus;
generating a common key corresponding to image data;
encrypting the image data using said common key to generate encrypted image data;
encrypting said common key using said public key to generate encrypted-common-key information; and
storing said encrypted-common-key information in said specific individual storage area associated with said public key used in generating said encrypted-common-key information.
